(19) United States
(12) Patent Application Publication
(10) Pub. No.: US 2009/0221662 A1
(43) Pub. Date: Sep. 3, 2009

(54) Method for Controlling Arthropods

(75) Inventors: Volker Gutsmann, Langenfeld (DE); Guenther Nentwig, Leverkusen (DE); Rainer Sonneck, Leverkusen (DE); Thomas Böcker, Leichlingen (DE)

Correspondence Address: Baker Donelson Bearman, Caldwell & Berkowitz, PC, 555 Eleventh Street, NW, Sixth Floor, Washington, DC, 20004, US

(73) Assignee: Bayer CropScience AG, Monheim (DE)

(21) Appl. No.: 12/097,045

(22) PCT Filed: Dec. 4, 2006
(86) PCT No.: PCT/EP06/11603

§ 371 Date: Nov. 17, 2008

(30) Foreign Application Priority Data
Dec. 15, 2005 (DE) 10 2005 060 497.8

(51) Int. Cl. A01N 43/56; A01N 53/10; A01P 7/04; A01P 7/02

(52) U.S. Cl. 514/407; 514/531

(57) ABSTRACT

The present invention relates to a method for controlling arthropods by indirect contact action using the pesticides mentioned in the description.

The present invention relates to a novel method for controlling harmful arthropods in private and professional pest control, in particular in agriculture, in the protection of stored products, in the protection of materials, in vector control, in house and garden and also in forests.

The control in particular of arthropods which live inside or outside of public or private accommodation, such as apartments, houses, hospitals, food-processing companies, large kitchens, restaurants and other private or public facilities is of great importance from a hygienic point of view.

In the areas described, arthropods are controlled in most cases by sprays. Here, a highly concentrated insecticide-containing formulation is diluted with water and sprayed as an aqueous spray liquor at 25 to 100 ml/m² on the surfaces on which the arthropods to be controlled move. The arthropods are killed by contact with the insecticide coating.

This method has the disadvantage that not all surfaces with which the pests come into contact can be treated, and that it is difficult to reach all pests with this method since some of them remain in their hiding place. Furthermore, during application, all other operations have to be interrupted.

A further problem is due to the fact that some pests are capable of detecting insecticidally active compounds, in particular pyrethroids, in their surroundings and of avoiding specifically surfaces treated therewith. The resulting repellent effect reduces the efficacy, generally requiring one or more subsequent treatments.

To ensure the desired effectiveness of sprays, application rates of 7.5 to 500 mg of active compound/m² of treated area per application are required, depending on the class of chemically active compounds.

Another method for controlling arthropods using products having contact action are insecticide-containing dusts.

WO-A2-01/91560 describes formulations having arthropodicidal contact action by employing at least two ethereal vegetable oils in a suitable carrier.

In agriculture, the use of insecticide-containing gel-like formulations having contact action against lepidoptera, for example the coddling moth (Cydia pomonella), has been described (EP-A1-0 721 735 and WO-A1-97/05778). In addition to many other insects, activity against cockroaches is claimed, too; however, this is not illustrated with respect to application and action. In particular, no indirect contact effects of any kind are described.

In veterinary medicine, the use of acaricide-containing gel-like formulations with contact action against ticks (Ixodes rizinus) has been described (WO-A1-2005/015993). Here, too, no indirect activity effects in pest control have been described.

“Secondary Transmission of Toxic Baits in German Cockroach (Dictyoptera Blattellidae)”, Journal of Economic Entomology, 200, 93, pages 434 to 440, examines the influence of secondary effects on pest control. The study focuses on the following secondary effects:
(1) the effect of cannibalism on pest control, where bait-contaminated pests are eaten by other non-contaminated pests, is studied.
(2) Furthermore, the study looks at the spreading of insecticidally acting compositions by bait-infected pests, where the insecticidally acting composition is transferred by social contacts from the contaminated to the non-contaminated pests, for example by wounds caused by biting or by mutual feeling of the pests.
(3) A third point that is investigated in the study is the effect of residual bait adhering to the pests, which is distributed by the pests moving around, resulting in further pests being killed.

In all three partial aspects of the study, baits are used which, for the applicant, are disadvantageous in that they are only effective when ingested by the pest. Thus, the success of this passive method of pest control depends mainly on whether and to what extent the baits are eaten by the pests.

In summary, it may be stated that, firstly, the only control methods known are those in which a contact insecticide product with direct action is, frequently in the form of an aqueous spray solution, applied in a complicated manner. According to the known methods, the compositions have to be applied to a large area. Large amounts of spray and high active compound application rates are therefore required. These known methods also have the disadvantage that they display weaknesses in their activity against resistant arthropods, may cause repellent effects in the case of pyrethroid-containing sprays and require all operations in the rooms to be treated to be interrupted during the application of the product. Secondly, methods for pest control using locally, as passive methods, baits, are known. These methods are disadvantageous owing to the fact that they rely on baits being ingested by the pests.

There was a need for a method for arthropod control which, in a short period of time, kills essentially the entire pest population and does not have the disadvantages mentioned above.

Accordingly, the present invention relates to an active method of arthropod control which is based on an indirect and very efficient contact action. In the context of the present invention, an active method is to be understood as meaning a method whose effectiveness is essentially independent of the feeding behaviour of the arthropods.

Accordingly, the invention provides a method for controlling arthropods wherein an effective amount of a pesticide is applied to surfaces on which the arthropods spend time, on which they move and/or on which they will move, characterized in that the pesticide
a) kills by contact alone,
b) is applied in small amounts in small areas,
c) comprises at least one insecticidally active compound,
d) is a viscous liquid,
e) adheres to the arthropods so well that it is spread by the arthropods in the surrounding
area,
f) optionally comprises attractants,
g) optionally comprises UV-absorbing substances,
h) optionally comprises one or more synergists,
i) optionally comprises other additives.

The pesticide to be used according to the invention has contact action against arthropods and is applied in small amounts to small areas.

According to the invention, small amounts refer to amounts of active compound of as little as generally from 0.1 to 10 mg of active compound per m², preferably from 0.25 to 5 mg of active compound per m², particularly preferably from 0.5 to 2.5 mg of active compound per m². Thus, with respect to the formulation, the amount of pesticide is generally between 10 and 1000 mg of formulation per m², preferably between 25 and 500 mg/m², particularly preferably between 50 and 250 mg/m². The formulations used in the method according to the invention are applied in a manner known to the person skilled in the art.

The pesticide can be used either as an open application directly to the areas on which the arthropods move (for example by way of a cartridge, a metered dispenser, syringes, brushes, spray cans), or covered in suitable devices (for example boxes, tubes and tunnels with access for the pests) or spread out on a suitable support (for example cardboard, plastic). The devices or supports are placed on the areas on which the arthropods move.

In the method according to the invention, the pesticide is preferably applied spread out, in the form of a line or in the form of a spot. With particular preference, the pesticide is applied only to a small area. In the case of application to an area, small area means that the pesticide is applied to an area of generally from 50 to 500 cm², in particular from 60 to 400 cm², preferably from 70 to 300 cm², particularly preferably from 80 to 200 cm². In addition, in the case of application as a spot, small area means that the pesticide is applied to generally from 1 to 50 cm², in particular from 2 to 40 cm², preferably from 3 to 30 cm², particularly preferably from 4 to 40 cm². Here, what is stated above refers to a total area of 25 m².

It is preferred for the application to be carried out not just at one site, but at different sites spread across the surface to be treated. In a preferred embodiment of the method according to the invention, the pesticide is applied to from 2 to 50, in particular from 3 to 40, preferably from 4 to 35, particularly preferably from 5 to 30, different sites spread on the surface. Here, what is stated above refers to a total area of 25 m².

In a preferred embodiment of the method according to the invention, the pesticide is not a bait.

The pesticide comprises one or more arthropodicidally, in particular insecticidally, active compounds. These are to be understood as meaning all customary substances suitable for controlling harmful insects. Preferred are carbamates, organic phosphorus compounds, arylpyrazoles, nitrophenols and derivatives thereof, nitromethylenes, nicotinoids, formamidines, ureas, phenylbenzoylureas, pyrethroids and chlorinated hydrocarbons. The following compounds may be mentioned as examples:

### Insecticides/Acaricides/Nematicides:

Acetylcholine esterase (AChE) inhibitors
Carbamates,
for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulphan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate
Organophosphates,
for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion

Sodium channel modulators/voltage-dependent sodium channel blockers
Pyrethroids,
for example acrinathrin, allethrin (d-cis-trans, d-trans), beta-cyfluthrin, bifenthrin, bioallethrin, bioallethrin-S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans-isomer), prallethrin, profluthrin, protrifenbute, pyresmethrin, resmethrin, RU 15525, silafluofen, tau-fluvalinate, tefluthrin, terallethrin, tetramethrin (1R isomer), tralomethrin, transfluthrin, ZXI 8901, pyrethrins (pyrethrum)
DDT
Oxadiazines,
for example indoxacarb

### Acetylcholine Receptor Agonists/Antagonists

Chloronicotinyls,
for example acetamiprid, clothianidin, dinotefuran, imidacloprid, nitenpyram, nithiazine, thiacloprid, thiamethoxam
Nicotine, bensultap, cartap

Acetylcholine receptor modulators
Spinosyns,
for example spinosad

GABA-controlled chloride channel antagonists
Organochlorines,
for example camphechlor, chlordane, endosulfan, gamma-HCH, HCH, heptachlor, lindane, methoxychlor
Fiprols,
for example acetoprole, ethiprole, fipronil, pyrafluprole, pyriprole, vaniliprole

Chloride channel activators
Mectins,
for example avermectin, emamectin, emamectin-benzoate, ivermectin, milbemycin

Juvenile hormone mimetics,
for example diofenolan, epofenonane, fenoxycarb, hydroprene, kinoprene, methoprene, pyriproxifen, triprene

Ecdysone agonists/disruptors
Diacylhydrazines,
for example chromafenozide, halofenozide, methoxyfenozide, tebufenozide

Chitin biosynthesis inhibitors
Benzoylureas,
for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron
Buprofezin
Cyromazine

Oxidative phosphorylation inhibitors, ATP disruptors
Diafenthiuron
Organotin compounds,
for example azocyclotin, cyhexatin, fenbutatin-oxide

Oxidative phosphorylation decouplers acting by interrupting the H-proton gradient
Pyrroles,
for example chlorfenapyr
Dinitrophenols,
for example binapacyrl, dinobuton, dinocap, DNOC

Site-I electron transport inhibitors
METI's,
for example fenazaquin, fenpyroximate, pyrimidifen, pyridaben, tebufenpyrad, tolfenpyrad
Hydramethylnon
Dicofol

Site-II electron transport inhibitors
Rotenone

Site-III electron transport inhibitors
Acequinocyl, fluacrypyrim

Microbial disruptors of the insect gut membrane
Bacillus thuringiensis strains

Lipid synthesis inhibitors
Tetronic acids,
for example spirodiclofen, spiromesifen
Tetramic acids,
for example spirotetramat
Carboxamides,
for example flonicamid
Octopaminergic agonists,
for example amitraz

Inhibitors of magnesium-stimulated ATPase,
Propargite
Benzodicarboxamides,
for example flubendiamide
Nereistoxin analogues,
for example thiocyclam hydrogen oxalate, thiosultap-sodium

Biologicals, hormones or pheromones
azadirachtin, Bacillus spec., Beauveria spec., codlemone, Metarrhizium spec., Paecilomyces spec., thuringiensin, Verticillium spec.

Active compounds with unknown or unspecific mechanisms of action
Fumigants,
for example aluminium phosphide, methyl bromide, sulphuryl fluoride
Antifeedants,
for example cryolite, flonicamid, pymetrozine
Mite growth inhibitors,
for example clofentezine, etoxazole, hexythiazox
amidoflumet, benclothiaz, benzoximate, bifenazate, bromopropylate, buprofezin, quinomethionate, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin

Particularly preferred as active compounds to be used according to the invention are representatives of the pyrethroids and arylpyrazoles. Very particular preference is given to deltamethrin and fipronil.

Preferably, the pesticide to be used in the method according to the invention comprises at least one only sparingly water-miscible oil. These are to be understood as meaning all oily liquids of synthetic or natural origin which contain straight-chain or branched, optionally functional groups, which have one or more unsaturated bonds between 2 carbon atoms and which have a solubility in water of less than 1 g/l. Preference is given to unsaturated oils of vegetable or animal origin which have a high content of unsaturated fatty acids. Examples of such oils are linseed oil, palm oil, arachis oil, cottonseed oil, soya oil, sunflower oil, rapeseed oil, castor oil and fish oil. Particular preference is given to castor oil. However, for preparing the compositions according to the invention, it is also possible to use the fatty acids present in the oils, or compounds which are obtained by chemical modification of the fatty acids, such as, for example, fatty acid ethoxylates. Examples of such fatty acids which may be employed on their own or as a mixture are myristoleic acid, palmitoleic acid, oleic acid, gadoleic acid, erucic acid, ricinoleic acid, linoleic acid, linolenic acid, arachidonic acid and clupanodonic acid.

By selecting a suitable combination of active compound and sparingly water-miscible oil, preferably, a pesticide viscosity suitable in the context of the present invention is obtained.

Here, the viscosity of the liquid is preferably chosen such that it initially adheres to the surface to be treated, but simultaneously adheres to the arthropods to be controlled sufficiently well so that, on contact with this liquid, they spread the pesticide until they die.

According to the invention, it was found that the resulting pesticide preferably has a viscosity of from 400 to 100 000 mPa·s, particularly preferably from 900 to 60 000 mPa·s, more preferably from 1500 to 40 000 mPa·s. Here, the viscosity is determined using a Haake viscosimeter RS 150, measuring in beaker Z20 with a shear rate of 7.5 [1/s].

The adhesive properties can also be achieved by using sugar syrups. Accordingly, in a further embodiment of the present invention, the pesticide to be used in the method according to the invention comprises a sugar syrup or a mixture of different sugar syrups. Sugar syrups which may be mentioned in this respect are inverted sugar syrups, molasses, special sugar syrups, caramel sugar syrups, mixed syrups and glucose syrups.

The viscosity may also be adjusted by using thickeners. These thickeners can be used on their own or as a mixture of two or more agents in any ratio. Suitable for use as thickeners are organic and inorganic macromolecules. Organic macromolecules which may be mentioned are cellulose derivatives, for example hydroxypropylcellulose, hydroxyethylcellulose, methylcellulose, carboxymethylcellulose-sodium, hydroxypropylmethylcellulose, hydroxyethylmethylcellulose, hydroxyethylpropylcellulose and also xanthans, alginates, carrageenan, agar-agar, polyvinyl alcohols, polyvinylpyrrolidone, polyacrylic acid and polymethacrylic acid. Inorganic macromolecules (inorganic gel formers) which may be mentioned are finely divided silica and hydrophobicized derivatives thereof, and bentonite (for example Rudolf Voigt, Pharmazeutische Technologie [Pharmaceutical Technology], pages 362-385, Ulstein Mosby).

Preference is given to using methylcellulose, hydroxyethylcellulose, carboxymethylcellulose-sodium, hydroxypropylcellulose, xanthans, polyacrylic acid and polymethacrylic acid, finely divided silica and hydrophobicized derivatives thereof.

Particular preference is given to using methylcellulose, hydroxyethylcellulose, carboxymethylcellulose-sodium, polyacrylic acid, finely divided silica and hydrophobicized derivatives thereof.

In general, the formulations of the pesticide to be used according to the invention also comprise emulsifiers.

Suitable emulsifiers are all customary nonionic, anionic, cationic and zwitterionic compounds having surface-active properties which are customarily used in agrochemical compositions. These compounds include reaction products of fatty acids, fatty esters, fatty alcohols, fatty amines, alkylphenols or alkylarylphenols with ethylene oxide and/or propylene oxide and/or butylene oxide, and also sulphuric esters, phosphoric monoesters and phosphoric diesters thereof, furthermore reaction products of ethylene oxide with propylene oxide, furthermore alkylsulphonates, alkyl sulphates, aryl sulphates, tetraalkylammonium halides, trialkylarylammonium halides and alkylaminesulphonates. The emulsifiers can be employed on their own or else as a mixture. Reaction products of castor oil with ethylene oxide in a molar ratio of from 1:20 to 1:60, reaction products of C₆-C₂₀-alcohols with ethylene oxide in a molar ratio of from 1:5 to 1:50, reaction products of fatty amines with ethylene oxide in a molar ratio of from 1:2 to 1:25, reaction products of 1 mol of phenol with 2 to 3 mol of styrene and 10 to 50 mol of ethylene oxide, reaction products of C₈-C₁₂-alkylphenols with ethylene oxide in a molar ratio of from 1:5 to 1:30, alkylglycosides, C₈-C₁₆-alkylbenzenesulphonic acid salts, such as, for example, calcium, monoethanolammonium, diethanolammonium and triethanolammonium salts may be mentioned as being preferred.

Examples of nonionic emulsifiers which may be mentioned are the products known under the names Pluronic PE 10 100 (from BASF), Atlox 4913 (from Uniqema) and Emulgator KS (from Lanxess AG). Also suitable are tristyrylphenyl ethoxylates. Examples of anionic emulsifiers which may be mentioned are the Lanxess AG product commercially available under the name Baykanol SL (=condensate of sulphonated ditolyl ether with formaldehyde), and also phosphated or sulphated tristyrylphenol ethoxylates, where special mention may be made of Soprophor FLK and Soprophor 4D 384 (from Rhodia).

It may be possible to improve the activity further using additives. The following compounds may be employed.
Attractants, such as sexual pheromones, aggregation pheromones and aromas (artificial, identical to the natural product or natural). Particular preference is given to Blatella quinones, periplanone A, periplanone B and Supella pyrones, and also to LEJ829L (parahydroxyphenylacetic acid), banana aroma, cherry aroma and also blackcurrant aroma.
UV absorbers: these are to be understood as meaning substances capable of absorbing UV light, preferably UV radiation from sunlight in a wavelength range of from 270 to 400 nm.
Synergists: these are to be understood as meaning substances which, together with the insecticidally active compound, achieve superadditive activity, for example piperonyl butoxide, MGK 264 (octacide) or sesamex.
Other additives, such as Bitrex, dyes, pigments.

The concentrations of the components individually mentioned above in the compositions in which the method according to the invention is based can be varied within a relatively wide range. Thus, the concentrations present after removal of any water contained in the compositions used, if present, are
of arthropodicidally active compounds generally between 0.1 and 10% by weight, preferably between 0.5 and 5% by weight, very particularly preferably between 0.5 and 2% by weight,
of viscous liquids with good adherence generally between 10 and 99% by weight, preferably between 50 and 95% by weight, very particularly preferably between 80 and 95% by weight,
of attractants generally between 0.01 and 5% by weight, preferably between 0.05 and 1% by weight, very particularly preferably between 0.05 and 0.2% by weight,
of UV absorbers generally between 1 and 40% by weight, preferably between 5 and 20% by weight, particularly preferably between 5 and 10% by weight,
of additives generally between 1 and 70% by weight, preferably between 2 and 35% by weight, very particularly preferably between 3 and 20% by weight.

Advantageously, the pesticide to be used according to the process according to the invention may be present as a ready-to-use formulation. Thus, we have found a novel, simple and highly effective method for controlling arthropods which, by making use of an insecticide-containing ready-to-use viscous formulation, overcomes the disadvantages of conventional sprays.

When the method according to the invention was employed, it was found that, after contact of the arthropods with this formulation, a small portion of the viscous liquid adheres to the arthropods and is released by the arthropods themselves on surfaces, in particular in their hiding place. Here, it is extremely surprising that a single contact of other arthropods with these surfaces provided with pesticide by the arthropods themselves is sufficient to kill these pests, too, rapidly and reliably. In the context of the present invention, this is understood as an action referred to as indirect.

Furthermore, it was surprising that there is a pronounced flushing-out effect by the composition carried into the hiding places of the arthropods. This flushing-out effect results in an increased contact of the normally not mobile stages of a pest population with the insecticidal composition, which considerably enhances the overall success of the treatment. In a particular embodiment of the present invention, the method is therefore a method for controlling arthropods where the arthropods are killed by contact with a pesticide and the pesticide is distributed by the arthropods themselves.

By virtue of the specially selected type of formulation of the pesticide for the method according to the invention, there are, surprisingly, no repellent effects as in the case of other compositions, in particular pyrethroids.

The method according to the invention reliably controls even arthropods which have developed resistance to chemically active compounds or formulation ingredients of conventional pesticides.

With good results, the method according to the invention can be employed for killing harmful or nuisance arthropods, in particular insects living socially or in close contact with one another. The method according to the invention is suitable for controlling harmful or nuisance arthropods both in buildings, such as, for example, accommodation, and in the immediate vicinity of buildings, and outdoors. A further area of use is the protection of entry points into buildings, such as, for example, doors and windows (so-called perimeter treatment).

The method according to the invention is based on the targeted application of a pesticide advantageously already present in a ready-to-use form to the surfaces frequented by the arthropods, inside and outside of buildings. These surfaces may be located within hiding places (for example in drawers, forebuildings, pipes, cracks and gaps), and also outside (for example in corners, on edges, on covering strips).

By applying very small amounts of active compound/m² at a few sites (such as, for example, only individual points), the method according to the invention allows the control of the entire pest population within a very short period of time.

In the method according to the invention, high efficacy is achieved even if one or more parts of the body of the arthropods (for example antenna, foot, mouth parts) come into contact with the composition only once. Since the arthropod continues moving until the action sets in, small amounts of the formulation are spread on surfaces. These small amounts are sufficient to kill other arthropods using the same paths by indirect contact action. The insecticide-containing formulation is also transferred by social contact between the arthropods.

In the case of some synthetic pyrethroids, by virtue of the method according to the invention, there is a pronounced activity-enhancing flushing-out effect once the composition is introduced into the hiding places of the arthropods.

With very good results, the method according to the invention can be used for controlling harmful or nuisance arthropods in private and professional pest control, in termite control, in agriculture, in the protection of stored products, in the protection of materials, in vector control, in gardens and in forests. In particular, it may be used against the arthropods listed below.

Arthropods having chewing/biting mouth parts include essentially bristle tails (Lepisma saccharina, Thermobia domestica), cockroaches (for example Blatella germanica, Periplaneta americana, Blatta orientalis, Supella longipalpa, Pycnoscelis surinamensis, Periplaneta australasiae, Periplaneta fuliginosa), termites (for example Coptotermes formosanus, Cryptotermes brevis, Cryptotermes cavifrons, Heterotermes aureus, Incisitermes minor, Mastotermes darwiniensis, Neotermes castaneus, Neotermes connexus, Prorhinotermes molinoi, Prorhinotermes oceanicus, Prorhinotermes simplex, Reticulitermes flavipes, Reticulitermes hergeni, Reticulitermes hesperus, Reticulitermes lucifugus, Reticulitermes santonensis, Reticulitermes tibialis, Reticulitermes virginicus, Zootermopsis angusticollis, Zootermopsis nevadensis), Saltatoria (for example Acheta domesticus, Locusta migratoria), Psocoptera (for example Trogium pulsatorium, Lachesilla pedicularia), beetles (for example Sitophilus granarius, Sitophilus oryzae, Tribolium confusum, Tribolium castaneum, Gnathoceros cornutus, Acanthoscelides obtectus, Rhizopertha dominica, Orycaephilus surinamensis, Tenebrio molitor, Tenebrioides mauretanicus, Stegobium paniceum, Lasioderma serricorne, Trogoderma granarium, Alphitobius fiaperinus, Dermestes lardarius, Anthrenus verbasci, Attageus pellio, Ptinus tectus, Niptus hololeucus, Anobium punctatum, Hylotrupes bajulus, Lyctus brunneus), ants (for example Camponotus herculaneus, Camponotus ferrugineus, Camponotus pennsylvanicus, Lasius niger, Linepithema humile, Monomorium minimum, Monomorium pharaonis, Solenopsis invicta, Tapinoma melanocephalum, Tapinoma sessile, Technomyrmex albipes), wasps (for example Vespula germanica, Vespula maculifrons, Vespula squamosa, Vespula vulgaris, Dolichovespula maculata), larvae of moths (for example Ephestia elutella, Ephestia cautella, Plodia interpunctella, Hofmannophila pseudospretella, Tineola bisselliella, Tinea pellionella, Trichophaga tapetziella), millipedes (for example Glomeris conspersa, Lithobius forficatus, Polyxenus fasciculatus, Scolopendra cingulata, Scolopendra heros, Scutigera coleoptrata) and woodlice (for example Porcellio scaber).

The arthropods having sucking or lapping mouth parts include essentially the representatives of the biting mosquitoes, in particular the Culicidae (for example Aedes aegypti, Aedes albopictus, Aedes vexans, Culex quinquefasciatus, Culex pipiens, Culex tarsalis, Anopheles albimanus, Anopheles arabiensis, Anopheles gambiae, Anopheles maculipennis, Anopheles stephensi, Mansonia titillans), Psychodidae (for example Phlebotomus papatasii, Psychoda alternata), Ceratopogonidae (for example Culicoides furens, Culicoides pulicaris), Simuliidae (for example Simulium colobaschense, Simulium damnosum), Stomoxidinae (for example Stomoxys calcitrans), Tsetse flies/Glossinae (for example Glossina morsitans, Glossina palpalis, Glossina swynnertoni), Tabanidae (for example Tabanus nigrovittatus, Haematopota pluvialis, Chrysops caecutiens), Drosophilidae (for example Drosophila melanogaster), Muscidae (for example Musca domestica, Musca autumnalis, Musca vetustissima, Fannia canicularis), Sarcophagidae (for example Sarcophaga carnaria), flies which cause myiasis (for example Lucilia cuprina, Lucilia sericata, Chrysomyia chloropyga, Hypoderma bovis, Hypoderma lineatum, Dermatobia hominis, Oestrus ovis, Gasterophilus intestinalis, Cochliomyia hominivorax, Calliphora vicina, Phormia regina) and Heteroptera (for example Cimex hemipterus, Cimex lectularius, Rhodnius prolixus, Triatoma infestans), lice/Phthiraptera (for example Pediculus capitis, Pediculus corporis, Phthirus pubis, Haematopinus suis, Damalina ovis), fleas/Siphonaptera(for example Pulex irritans, Xenopsylla cheopis, Ctenocephalides canis, Ctenocephalides felis, Tunga penetrans). The arachnids include mites (for example Dermatophagoides pteronyssinus, Dermatophagoides farinae, Euroglyphus mayneri, Dermanyssus gallinae, Sarcoptes scabiei, Acarus siro, Neotrombicula autumnalis), ticks (for example Ixodes ricinus, Argas reflexus, Ornithodorus moubata, Boophilius microplus, Amblyomma hebraeum, Rhipicephalus sanguineus, Dermacentor marginatus), spiders (for example Atrax robustus, Latrodectus mactans, Loxosceles reclusa, Phoneutria nigriventer) and scorpions (for example Androctonus amoreuxi, Buthus occitanus, Centruroides exilicauda, Hadrurus arizonensis, Leirus quinquestriatus).

The method according to the invention is preferably employed against crawling insects, in particular representatives of the orders Orthoptera, Isoptera, Heteroptera, Hymenoptera and Coleoptera and very particularly preferably against the representatives of the order Blattaria (for example Blatella germanica, Periplaneta americana, Blatta orientalis, Supella longipalpa, Pycnoscelis surinamensis, Periplaneta australasiae, Periplaneta fuliginosa), Isoptera(for example Coptotermes formosanus, Cryptotermes brevis, Cryptotermes cavifrons, Heterotermes aureus, Incisitermes minor, Mastotermes darwiniensis, Neotermes castaneus, Neotermes connexus, Prorhinotermes molinoi, Prorhinotermes oceanicus, Prorhinotermes simplex, Reticulitermes flavipes, Reticulitermes hergeni, Reticulitermes hesperus, Reticulitermes lucifugus, Reticulitermes santonensis, Reticulitermes tibialis, Reticulitermes virginicus, Zootermopsis angusticollis and Zootermopsis nevadensis), Hymenoptera(for example Camponotus herculaneus, Camponotus ferrugineus, Camponotus pennsylvanicus, Lasius niger, Linepithema humile, Monomorium minimum, Monomorium pharaonis, Solenopsis invicta, Tapinoma melanocephalum, Tapinoma sessile, Technomyrmex albipes) and Heteroptera (for example Cimex hemipterus, Cimex lectularius, Rhodnius prolixus, Triatoma infestans).

Most preferably, the method according to the invention is suitable for controlling cockroaches (representatives of the order Blattaria), ants (representatives of the order Hymenoptera) and termites (representatives of the order Isoptera).

The working examples below illustrate the method according to the invention, but do not limit the present invention.

### WORKING EXAMPLES

The method according to the invention and the mode of action it is based on are illustrated in the examples below.

### Formulation Example 1

A recipe comprises the following components:

| Compound | Concentration |
|---|---|
| Deltamethrin | 1.0% |
| (active compound) | |
| Aerosil R 974 | 5.0% |
| Emulgator KS | 0.5% |
| Castor Oil | 93.5% |

The castor oil is initially charged in a beaker and, with stirring (toothed-disc stirrer), heated to 80° C. At this temperature, the deltamethrin is added, and the mixture is stirred for 120 minutes. The Aerosil is then added, and stirring at 80° C. is continued for a further 10 minutes. After addition of the emulsifier and further stirring at 80° C. for 10 minutes, the gel formed is, with stirring, cooled to room temperature.

### Example A

To examine how quickly the action sets in after single contact, the hind foot of in each case one male German cockroach (Blatella germanica) is brought into contact for a short time with the contact formulations to be tested. After this short and single contact, the insect is transferred into a plastic beaker (base: 7.5 cmø, height: 9.5 cm) which is closed with a transparent lid. The time until the knock-down effect sets in is measured. This “time to knock-down” is taken as a measure for how rapidly the insecticidal action of the composition in question sets in. The lower the value, the more rapidly acting the formulation.

The test results are shown in the table below.

| | Time to knock-down | | | | | |
|---|---|---|---|---|---|---|
| Formulation | Insect | Insect 2 | Insect 3 | Insect 4 | Insect 5 | Mean |
| 4.00% Cyfluthrin | 23′40″ | 25′30″ | 32′20″ | 29′00″ | 34′20″ | 28′58″ |
| 2.00% Cyfluthrin | 41′ | 2 h 30′ | 2 h 00′ | 2 h 45′ | 1 h 04′ | 1 h 48′ |
| 1.00% Cyfluthrin | 3 h 30′ | 5 h 15′ | 5 h 15′ | 7 h 0′ | 1 h 20′ | 4 h 28′ |
| 0.50% Cyfluthrin | 5 h 15′ | 24 h | 3 h 30′ | 1 h 20′ | 5 h 15′ | 7 h 52′ |
| 2.00% Deltamethrin | 13′50″ | 35′10″ | 20′30″ | 17′40″ | 30′20″ | 23′30″ |
| 1.00% Deltamethrin | 7′10″ | 10′10″ | 6′50″ | 22′00″ | 22′50″ | 13′48″ |
| 0.50% Deltamethrin | 26′50″ | 29′10″ | 24′40″ | 12′40″ | 15′30″ | 21′46″ |
| 0.25% Deltamethrin | 21′30″ | 52′20″ | 2 h 00′ | 51′50″ | 59′10″ | 1 h 01′ |

For the example a formulation according to Formulation Example 1 is used, where the active compound is varied in accordance with the table above and different amounts of active compound are made up for by appropriate adjustment of the amount of castor oil compared to Formulation Example 1.

### Example B

To test for efficacy after direct contact of harmful insects, a mixed population (5 male, 5 female, 10 intermediate larval stages of the German cockroach (Blatella germanica)) is established in a test arena (50×60 cm, height 15 cm), internal walls covered with talc. In this test arena, there is a drinker (far third), and in one of the far corners there is a hiding place and in one of the near corners a piece of biscuit. After one day, the cockroaches are exposed to the method according to the invention, i.e. 200 mg of the viscous formulation are placed in a Petri dish in the free close corner of the test arena. For quantitative evaluation of the efficacy, the mortality of the adult animals and larvae is determined separately, 1, 2, 3 and 6 days after the start of the test.

The test results are shown in the table below.

| | % Mortality | | | | | | | |
|---|---|---|---|---|---|---|---|---|
| | Adult | | | | Larvae | | | |
| Formulation | 1 d | 2 d | 3 d | 6 d | 1 d | 2 d | 3 d | 6 d |
| 4.00% Cyfluthrin | 100 | 100 | 100 | 100 | 100 | 100 | 100 | 100 |
| 2.00% Cyfluthrin | 100 | 100 | 100 | 100 | 100 | 100 | 100 | 100 |
| 1.00% Cyfluthrin | 100 | 100 | 100 | 100 | 100 | 100 | 100 | 100 |
| 0.50% Cyfluthrin | 100 | 100 | 100 | 100 | 100 | 100 | 100 | 100 |
| 2.00% Deltamethrin | 100 | 100 | 100 | 100 | 100 | 100 | 100 | 100 |
| 1.00% Deltamethrin | 100 | 100 | 100 | 100 | 100 | 100 | 100 | 100 |
| 0.50% Deltamethrin | 100 | 100 | 100 | 100 | 100 | 100 | 100 | 100 |
| 0.25% Deltamethrin | 100 | 100 | 100 | 100 | 100 | 100 | 100 | 100 |

For the example a formulation according to Formulation Example 1 is used, where the active compound is varied in accordance with the table above and different amounts of active compound are made up for by appropriate adjustment of the amount of castor oil compared to Formulation Example 1.

### Example C

To test the indirect efficacy, after the test has ended the first presentation of the composition is removed from the test arenas of Example B, as are all dead insects. A new mixed group of male and female animals and larvae of the German cockroach (Blatella germanica) is then placed together in this test arena. During the entire duration of the test, the animals have access to feed, water and the hiding place from Example B. For quantitative evaluation of the efficacy, the mortality of the adult animals and larvae is determined separately, 1, 2, 3 and 6 days after the start of the test.

The test results are shown in the table below.

| | % Mortality | | | | | | | |
|---|---|---|---|---|---|---|---|---|
| | Adult | | | | Larvae | | | |
| Formulation | 1 d | 2 d | 3 d | 6 d | 1 d | 2 d | 3 d | 6 d |
| 4.00% Cyfluthrin | 100 | 100 | 100 | 100 | 100 | 100 | 100 | 100 |
| 2.00% Cyfluthrin | 100 | 100 | 100 | 100 | 100 | 100 | 100 | 100 |
| 1.00% Cyfluthrin | 100 | 100 | 100 | 100 | 93 | 100 | 100 | 100 |
| 0.50% Cyfluthrin | 100 | 100 | 100 | 100 | 100 | 100 | 100 | 100 |
| 2.00% Deltamethrin | 100 | 100 | 100 | 100 | 100 | 100 | 100 | 100 |
| 1.00% Deltamethrin | 100 | 100 | 100 | 100 | 100 | 100 | 100 | 100 |
| 0.50% Deltamethrin | 100 | 100 | 100 | 100 | 100 | 100 | 100 | 100 |
| 0.25% Deltamethrin | 93 | 93 | 93 | 93 | 93 | 93 | 93 | 93 |

For the example a formulation according to Formulation Example 1 is used, where the active compound is varied in accordance with the table above and different amounts of active compound are made up for by appropriate adjustment of the amount of castor oil compared to Formulation Example 1.

1. Method for controlling arthropods comprising applying an effective amount of a pesticide to surfaces on which arthropods spend time, on which they move and/or on which they will move, wherein the pesticide
a) kills by contact alone,
b) is applied in small amounts in small areas,
c) comprises at least one insecticidally active compound,
d) is a viscous liquid,
e) adheres to the arthropods so well that said compound is spread by the arthropods in a surrounding area,
f) optionally comprises attractants,
g) optionally comprises UV-absorbing substances,
h) optionally comprises one or more synergists,
i) optionally comprises other additives.

2. Method according to claim 1, wherein the pesticide is present as ready-to-use formulation of a desired viscosity.

3. Method according to claim 1, wherein adherence of said pesticide is achieved by adding a sparingly water-miscible oil and/or a sugar syrup.

4. Method according to claim 1, wherein the insecticidally active compound is deltamethrin and/or fipronil.

5. Method according to claim 1, wherein the arthropods are insects.

6. Method according to claim 1, wherein the insects are cockroaches, termites and/or ants.

7. Method according to claim 2, wherein adherence of said pesticide is achieved by adding a sparingly water-miscible oil and/or a sugar syrup.

8. Method according to claim 2, wherein the insecticidally active compound is deltamethrin and/or fipronil.

9. Method according to claim 3, wherein the insecticidally active compound is deltamethrin and/or fipronil.

10. Method according to claim 2, wherein the arthropods are insects.

11. Method according to claim 3, wherein the arthropods are insects.

12. Method according to claim 4, wherein the arthropods are insects.

13. Method according to claim 2, wherein the insects are cockroaches, termites and/or ants.

14. Method according to claim 3, wherein the insects are cockroaches, termites and/or ants.

15. Method according to claim 4, wherein the insects are cockroaches, termites and/or ants.

16. Method according to claim 5, wherein the insects are cockroaches, termites and/or ants.
